(19) United States
(12) Patent Application Publication
(10) Pub. No.: US 2007/0006520 A1
(43) Pub. Date: Jan. 11, 2007

(54) Insect trapping apparatus with fog generator

(75) Inventor: Emma Amelia Durand, Jamestown, RI (US)

Correspondence Address: PILLSBURY WINTHROP SHAW PITTMAN, LLP, P.O. BOX 10500, MCLEAN, VA, 22102, US

(73) Assignee: American Biophysics Corporation, North Kingstown, RI (US)

(21) Appl. No.: 11/481,000

(22) Filed: Jul. 6, 2006

Related U.S. Application Data
(60) Provisional application No. 60/696,523, filed on Jul. 6, 2005.
(60) Provisional application No. 60/811,417, filed on Jun. 7, 2006.

(51) Int. Cl. A01M 19/00; A01N 25/08

(52) U.S. Cl. 43/129; 424/410

(57) ABSTRACT

The present application discloses an insect trapping apparatus that has a fog generator for generating a fog comprising at least one attractant.

The present application claims priority to U.S. Provisional Application Ser. No. 60/696,523, filed Jul. 6, 2005, and U.S. Provisional Application Ser. No. 60/811,417, filed Jun. 7, 2006, the entirety of which are incorporated herein by reference.

### FIELD OF THE INVENTION

The present invention relates to insect trapping apparatuses, such as those designed for luring and trapping flying insects using one or more attractants.

### BACKGROUND OF THE INVENTION

Prior art insect trapping apparatus have relied on combusting a fuel such as propane, to generate an outflowing exhaust gas with a high CO₂ content. The exhaust gas attracts the insects to the apparatus, which has an inflow for drawing the insects into a trap chamber, such as a mesh bag. Examples of such devices are disclosed in U.S. Pat. Nos. 6,145,243, 6,840,005 and 6,892,492, and U.S. Patent Application Nos. 2004-0244276 A1 and 2004-0237382 A1.

The present invention endeavors to take a different approach to generating an outflow that is attractive to flying insects.

### SUMMARY OF THE INVENTION

One aspect of the invention provides an insect trapping apparatus that has a fog generator for generating a fog comprising at least one attractant. The use of a fog for dispersing the attractant is believed to be advantageous for attracting and capturing insects.

The device comprises a frame providing at least one outlet opening and at least one inlet opening. Each of the outlet and inlet openings are communicated, either directly or indirectly, to a surrounding atmosphere. An insect trap chamber is communicated to the surrounding atmosphere through the at least one inlet opening. At least one airflow generator is operable to generate an inflow flowing inwardly from the surrounding atmosphere through the at least one inlet opening and then into the insect trap chamber. This enables the inflow to draw insects attracted to the device into the insect trap chamber.

The device also comprises an attractant supply comprising an insect attractant and a liquid. The attractant supply may have any form, and the liquid and the attractant may be together in one container as a solution or mixture, or the liquid and the attractant may be contained in separate containers. The term container refers to any structure that contains the attractant or the liquid, or both, and may be an integral part fixed to the apparatus, or a removable part.

A feeder is provided for feeding the attractant and the liquid, and a fog generator is in communication with the feeder such that the feeder feeds the attractant supply to the fog generator. The fog generator is also in communication with the at least one outlet opening and is operable to generate a fog comprising the liquid and the insect attractant for exiting through the at least one outlet opening for attracting insects to the device.

Another aspect of the invention provides a method for attracting and capturing flying insects using a fog comprising at least one attractant. The method uses an insect trapping apparatus comprising a frame providing at least one outlet opening and at least one inlet opening, each of the outlet and inlet openings being communicated to a surrounding atmosphere; an insect trap chamber communicated to the surrounding atmosphere through the at least one inlet opening; and at least one airflow generator operable to generate an inflow flowing inwardly from the surrounding atmosphere through the at least one inlet opening and then into the insect trap chamber, thereby enabling the inflow to draw insects attracted to the device into the insect trap chamber. The method comprises:

emitting a fog comprising a liquid and an insect attractant through the at least one outlet opening for attracting insects to the device; and

generating, with the at least one airflow generator, the inflow flowing inwardly from the surrounding atmosphere through the at least one inlet opening and then into the insect trap chamber, thereby enabling the inflow to draw insects attracted to the device by the fog into the insect trap chamber.

Other objects, aspects, and advantages of the present invention will become apparent from the following detailed description, the accompanying drawings, and the appended claims.

### BRIEF DESCRIPTION OF THE DRAWINGS

FIG. 1 is a profile view of an insect trapping apparatus constructed in accordance with the present invention;

FIG. 2 is a side view schematically showing various internal components of the insect trapping apparatus of FIG. 1;

FIG. 3 is a close-up detail view showing the subject matter in circle A in FIG. 2;

FIG. 4 is a schematic view of selected internal components of the apparatus of FIG. 1;

FIG. 5 is a schematic view showing only the reservoir, the atomizer, the outlet nozzle, and the feedline from FIG. 4;

FIG. 6 is a schematic view with similar components to FIG. 4;

FIG. 7 is a schematic view similar to FIG. 4, but showing an alternative construction where no reservoir is used;

FIG. 8 is a schematic view showing only the fog generator and the feedlines from FIG. 7;

FIG. 9 is a schematic view of a mounting arrangement for removably mounting a fog generator in an open position with the fog generator partially inserted;

FIG. 10 shows the fog generator fully inserted into the mounting arrangement of FIG. 9;

FIG. 11 shows the fog generator fully inserted into the mounting arrangement of FIG. 9 in the closed position;

FIG. 12 shows a profile view of a base unit with a liquid container integrally provided thereon;

FIG. 13 is a schematic flowchart for controlling operation of an insect trapping apparatus;

FIG. 14 is a top view of an alternative fog generator;

FIG. 15 illustrates an example of a pouch containing liquid attractant; and

FIG. 16 is an isolated cross-sectional view of an attractant release device.

### DETAILED DESCRIPTION OF THE ILLUSTRATED EMBODIMENT(S)

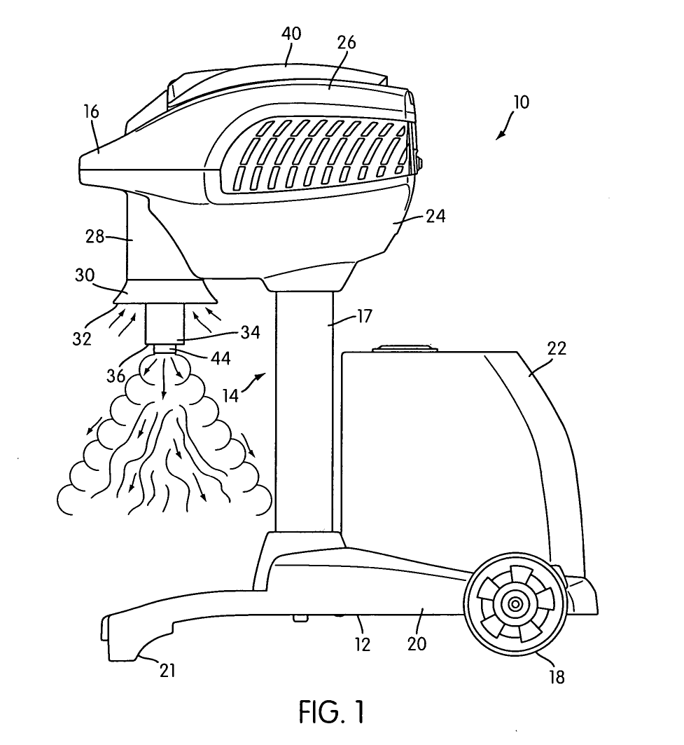

FIG. 1 shows an exemplary flying insect trapping apparatus, generally indicated at 10, constructed in accordance with the present invention. Broadly speaking, the general function of the device 10 is to emit a fog F containing at least one insect attractant to attract mosquitoes and other flesh biting insects. Then, an inflow draws the attracted insects into a trap chamber within the device, where the insects are captured and killed by poison or dehydration/starvation. Alternatively, a user engaged in the study of insects may opt to not kill the captured insects and instead may remove them from the device 10 prior to dying for purposes of live examination. Regardless of the specific insect capturing purpose the user has in mind, the overall function of the device 10 is to attract and capture flying insects. The specifics of how the present invention operates to achieve this broad general function is discussed below.

The device 10 comprises a supporting frame structure, generally indicated at 14. The supporting frame 14 includes a housing 16 supported on a single vertically extending leg 17 that extends upward from a base 12. In the illustrated embodiment, one leg 17 is used to support the housing 16, although multiple legs may be used, or other structures besides legs could be used. Additionally, the frame may include wheels 18, as shown in FIG. 1. Further, the supporting frame 14 may also include a supporting deck 20 for carrying a container 22, which will be discussed below, so that the frame 14 and the container 22 can be transported together as a unit. As illustrated, the wheels 18 are rotatably mounted at one longitudinal end portion of the base 12 under the deck 20, and a pair of supporting legs 21 are mounted at the opposite longitudinal end portion of the base 12.

The supporting frame 14, however, may have any construction or configuration suitable for carrying the operative components discussed herein below. For example a tripod arrangement may also be used, or the apparatus may be built so as to be mounted to a wall or fence, as is shown in U.S. patent application Ser. No. 10/686,815. Any other suitable configuration may be used.

The housing 16 includes a bottom shell 24 and a top shell 26 mounted thereto. The shells 24 and 26 are coupled and secured together using conventional fasteners, adhesives, a snap-fit relation, or in any other suitable manner. In the illustrated embodiment, these shells 24 and 26 are molded from plastic; however, these shells 24, 26, and the housing 16 in general, may be made from any materials and may take any shape, configuration, or construction.

A tubular intake nozzle 28 protrudes downwardly from the bottom shell 24 and is formed integrally therewith. The intake nozzle 28 has a flared lower end 30 which is attached by fasteners or snap-fitting to, and thus forms a part of, the intake nozzle 28. The flared lower end 30 defines an insect inlet or inlet opening 32. As will be appreciated from the details provided below, a vacuum is applied to the nozzle 28 and the insects attracted to the fog F emanated by the device 10 will be drawn into the insect inlet 32 for capture. The intake nozzle 28 and the inlet 32 provided thereby may be carried on the frame 14 in any suitable matter and the construction illustrated and described is only an exemplary construction. Thus, other configurations may be used.

Concentrically mounted within the intake nozzle 28 is an outlet nozzle 34. The outlet nozzle 34 provides a fog outlet or outlet opening 36 on the lower end thereof. The function of the outlet nozzle 34 and its outlet 36 is to allow the fog F generated to flow outwardly and downwardly therefrom. Mosquitoes and other insects attracted to the fog F will be able to sense it and follow the same to its source, namely the outlet 36. As can be appreciated from the construction disclosed, because the outlet nozzle 34 is concentric with the intake nozzle 28, the attracted insects flying to the source of the fog F (i.e., the outlet 36) will be immediately adjacent the insect inlet 30 upon reaching the outlet 36. As a result, the attracted insects may fly into the vacuum zone created by the vacuum communicated to the intake nozzle 28 and its insect inlet 30, whereby they are drawn into the device 10 and captured therein. The respective flows of the vacuum intake and the fog F outflow are indicated by the inflow and outflow arrows in FIG. 1. For further details and variations on this aspect of the disclosed construction, reference may be made to the patents and applications mentioned above. Also, reference may be made to U.S. Pat. No. 6,286,249 filed Sep. 17, 1996.

The upper shell 26 of the housing 16 includes an access door 40 that can be moved between open and closed positions to open and close an access opening formed in the housing wall. The door 40 may be pivotally mounted to the upper shell 26 to facilitate its opening and closing movements by pivot pins or other structures. In the broader aspects of the invention the door 40 may be entirely separable from the housing 16, or may be connected for opening and closing movements using any suitable construction. In fact, the provision of the door 40 is not necessary at all and is simply a feature for convenience. The role of the access door 40 and its associated opening is to enable a user to gain access to the interior of the housing 16, but its provision is not necessary.

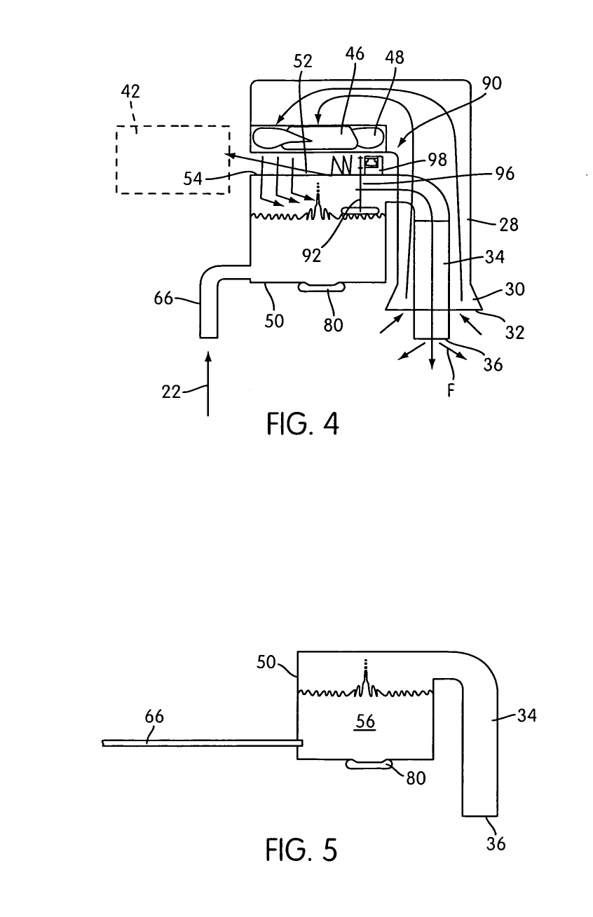

As will be described in further detail below, a mesh bag 42, the interior of which defines an insect trap chamber, is removably mounted within the housing 16. The mounting and use of such a bag is well-known, and it is shown schematically in FIG. 4. The chamber defined by the bag 42 is communicated to the insect inlet 30 so that the insects drawn in by the vacuum will be deposited in the bag 42 where they will become dehydrated and perish. Alternatively, the material of the bag 42 may be treated with a poison for purposes of facilitating the insect termination function; however, that is not a necessary feature of the invention. The access door 40 and its associated opening permit access into the interior of the housing 16 to allow the user to access the mesh bag 42 as desired for purposes of removal/replacement. Also, as another alternative, a plastic box or any other suitable structure may be used in place of mesh bag 42. In the disclosed embodiment, the door 40 is formed from a transparent material to enable the user to visually inspect the bag 42 to determine whether it needs removal/replacement. Specifically, the transparent material may enable the user to visually verify whether the bag 42 is at or near its full capacity of insects. In the broader aspects of the invention, the door 40 need not be transparent, and further, as mentioned previously, the device does not necessarily require the door 40 and its associated opening. For further details with regard to the mounting or access to the mesh bag 42, or other insect trap chamber, reference may be made to the patents/applications mentioned above.

An optional lure may be mounted in a housing 44, which is shown as being mounted inside the outlet nozzle 34. The construction of such a housing is known from other applications, such as U.S. Patent Application No. 2005-0019361 A1, and is not described in detail herein.

As mentioned above, the frame provides at least one outlet opening 36 and at least one inlet opening 32. Each of the outlet and inlet openings 32, 36 are communicated to the surrounding atmosphere. They may be provided on the frame 14 in any way and the illustrated concentric structure is not intended to be limiting. Instead, any suitable location for these openings may be used, and more than one of each or both openings may be used. For example, the openings may be located on different parts of the apparatus, and may be offset from one another, or be on different sub-components of the apparatus.

The mesh bag 42 provides the insect trap chamber, which is communicated to the surrounding atmosphere through the inlet opening 32. Specifically, as shown in FIG. 4, the inflow entering the inlet opening 32 is directed up the nozzle 30, then through a fan 46, and then into the mesh bag 42. Constructions for directing an inflow are well-known and need not be described herein in detail. Reference may be made to any one of the applications incorporated herein.

At least one airflow generator is provided, and in the illustrated embodiment this is provided by the fan 46. The fan 46, includes a motor that draws an electrical power signal and rotates its blades 48, thereby generating the inflow. Specifically, the fan 48 is operable to generate the inflow so that it is flowing inwardly from the surrounding atmosphere through the inlet opening 32 and then into the insect trap chamber provided by the mesh bag 40. This enables the inflow to draw insects attracted to the device into the insect trap chamber of the bag 40.

As can be seen in FIG. 4, a reservoir 50 is provided for the fog generator, which will be described below. The reservoir 50 has a top wall 52 with a series of openings 54. These openings 54 enable a portion of the airflow generated by the fan 46 to be diverted into the reservoir for purposes of exhausting the fog generated therein through the outlet opening 36. The openings 54 may be provided by a mesh screen so that air can flow in, while preventing insects from entering reservoir 50.

The airflow generator may be provided by a single fan as shown, or by multiple fans. Further, airflow may be generated by any other suitable device or devices for generating the inflow. Moreover, it is not necessary that the airflow generator be used to exhaust or assist in exhausting the fog outflow, although that is preferred. Any other suitable construction or arrangement may be used in place of the one illustrated.

The apparatus 10 also includes an attractant supply comprising an insect attractant and a supply of a liquid. This terminology is intended to encompass a wide range of embodiments. For example, the attractant supply could be constituted by a mixture or solution of an insect attractant and a base liquid in a single container. It also could be constituted by an insect attractant and a base liquid housed in separate containers. The base liquid may be any suitable liquid, such as water. Water is preferred because of its availability and low cost.

The insect attractant may be of any type suitable for attracting insects and may be in liquid or solid form. If it is in solid form, it is preferred that the attractant be in particulate form so that it more easily mixes into the liquid. Examples of suitable attractants may those having a molecular weight below 100, such as butyric acid and fatty acids (e.g., C4, C5, and C6 fatty acids). It is preferred that such attractants have high miscibility. Other attractants may also be used, such as those of a higher molecular weight, or having a lower miscibility, and the invention is not intended to be limited to the examples given.

Reference may be made to U.S. Provisional Application Ser. No. 60/811,417, filed Jun. 7, 2006, the entirety of which is incorporated herein by reference, for teachings of suitable attractants and compositions.

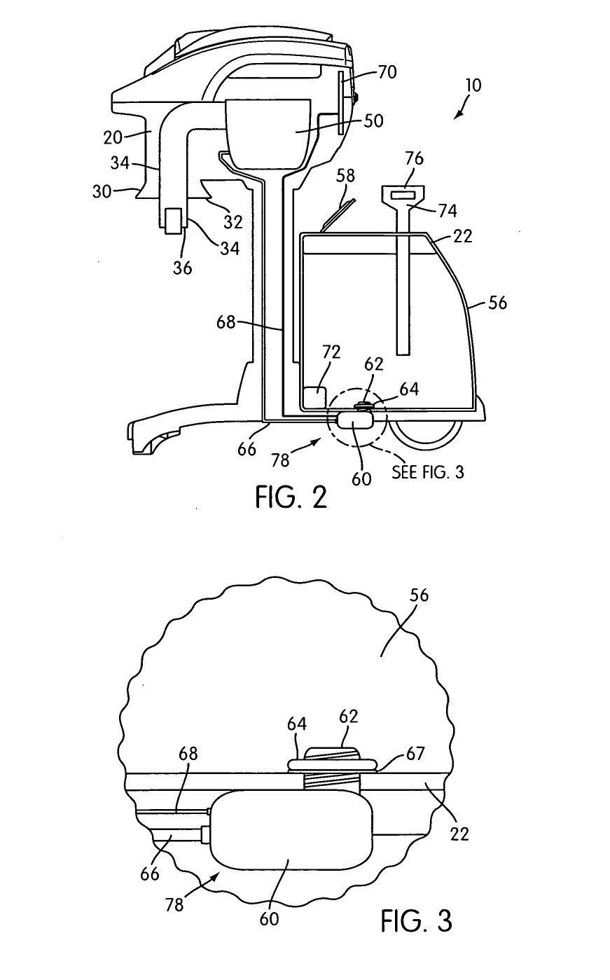

In the embodiment of FIGS. 1-4, the attractant supply is the liquid, preferably water, and the attractant mixed together as a solution. This solution is contained in container 22. The attractant and water solution is indicated at 56. The container has a lid 58 that covers an opening on the top wall of the container 22. FIG. 1 shows the lid closed, and FIG. 2 shows it open. The user may open the lid 58 for filling up the container 22. When the liquid used is water, the user would preferably fill the container with a hose, or from some other source of water. The attractant would be provided in a liquid or particulate form that the user could mix into the water to create the attractant/water solution 56.

Instead of the attractant being in solution in the water, the attractant and the water could merely be a mixture. A solution is preferred, because solutions do not separate, whereas in a mixture the attractant may fall out to the bottom of the container 22 over time. To avoid this, a small propeller or other agitator (not shown) may be placed in the container 22 if a mixture is to be used, thus allowing the mixture to be continuously mixed and prevent the attractant from separating or falling out.

FIG. 2 shows a pump 60 that is mounted underneath the container. The pump 60 is externally mounted, and has an inlet 62 that is inserted through an opening formed in the bottom wall of the container 22. This enables the pump 60 to draw the solution 56 from the container 22. To secure the pump 60 and its inlet tightly in a sealed manner, the inlet 62 is externally threaded and an internally threaded annular ring 64 is threaded onto the inlet. An annular gasket or seal 66 is provided between the ring 64 and the internal surface of the container's bottom wall to prevent leakage of the solution 56. The pump 60 has an outlet 64 to which a feed line 66 (such as plastic or metal tubing) is attached. Also, a power cord 68 is connected to the pump 60 and delivers power to the pump 60 for its operation. The power cord 68 is connected at its opposite end to a controller 70, which will be discussed later.

The pump 60 may be of any type and have any construction or configuration. The illustrated pump 60 and the method by which it is mounted is not intended to be limiting.

As an alternative, a submersible pump 72 could be provided inside the container 22 in lieu of the external pump 60. With this type of pump 72, the feedline 66 would be connected to it through an opening in the container wall in any well known manner for making such a connection.

As another alternative, a manual pump 74 may be provided. This manual pump 74 may be used in lieu of a powered pump, or in addition to a powered pump as a back-up in the event the powered pump fails. The manual pump 74 is of a well-known construction and has a handle 76 for grasping and facilitating a pumping action. The manual pump 74 operates by increasing air pressure in the space above the solution/mixture 56 so as to force the solution/mixture 56 into the feedline 66.

The pump 60 and the feedline 66 may be considered as constituting one possible variation for a feeder 78 for feeding the attractant and the liquid. Likewise, any of the other alternative pumps mentioned above, or any other device for feeding the attractant and the liquid, whether together in a solution/mixture or separate, may be considered as comprising a feeder for feeding the attractant and the liquid. Any suitable mechanism, system or device for feeding the liquid and the attractant may be considered as being a feeder.

A fog generator 80 is in communication with the feeder 78 such that the feeder 78 feeds the attractant supply to the fog generator 80. In the embodiment of FIGS. 1-4, this feeder 74 feeds the solution 56 from the container 66 to the reservoir 50. Specifically, the pump 60 pumps the solution 56 through feedline 66, which is connected at its opposite end to the reservoir 50. The fog generator 80 is mounted to the bottom wall of the reservoir 50.

The fog generator 80 used in this embodiment is of the submersible type and is operable to generate a fog from the solution in the reservoir 50. This fog F exits through the outlet nozzle 34, as the outlet nozzle 34 is in communication with the reservoir 50 and hence the fog generator 80 as shown in FIG. 4. Because the attractant and the liquid are in a solution or mixture together, the fog F will comprise droplets of the liquid and the attractant, which will ultimately exit the outlet opening 36 for attracting insects to the apparatus 10.

Preferably, the fog generator 80 is an electromechanical device. More preferably, the generator 80 is an ultrasonic device operable to vibrate at ultrasonic frequencies to generate the fog F. Such devices are known in the art, and need not be described herein in detail. They are sometimes referred to as atomizers or nebulizers. Preferably, but not necessarily, the fog generator 80 would be connected by wiring to the same controller 70 as the power cord 68 so that the delivery of electrical power to the fog generator 80 can be selectively controlled. Other types of devices for generating the fog F may also be used, and the invention is not intended to be limited to anyone specific type.

Examples of suitable ultrasonic fog generators are available from APC International, Ltd., located in Mackeyville, Pa. For example, a ceramic piezoelectric crystal type one may be used. From APC, examples for suitable model numbers for use are 50-1010 (1.65 MHz Nebulizer Board) and 50-1025 (2.4 MHz Nebulizer Board). Reference may be made to the APC's website at for information on those models:

http://www.americanpiezo.com/products_services/nebulizers.html.

According to that website:

$$droplet diameter = 0.73 \times {√}^{3} \frac{surface tension of liquid}{( density of liquid ) ( input {frequency}^{2} )}$$

Thus, the frequency of the generator selected has an effect on the resulting droplet size, among other factors. Accordingly, the frequency may be chosen to produce droplets within desired ranges. The range of 1.65 to 2.4 MHz, of which these APC examples are representative, is suitable for generating a fig with appropriate size droplets. Other frequencies outside that range may also be used.

In lieu of an ultrasonic device for generating fog, it is possible to use a misting nozzle type of approach to disperse the liquid into fine particles. The use of an ultrasonic device is preferred, as nozzles are susceptible to clogging and other issues. However, the use of a nozzle is within the scope of the invention. Other suitable devices other than nozzles or ultrasonic devices may also be used in the invention.

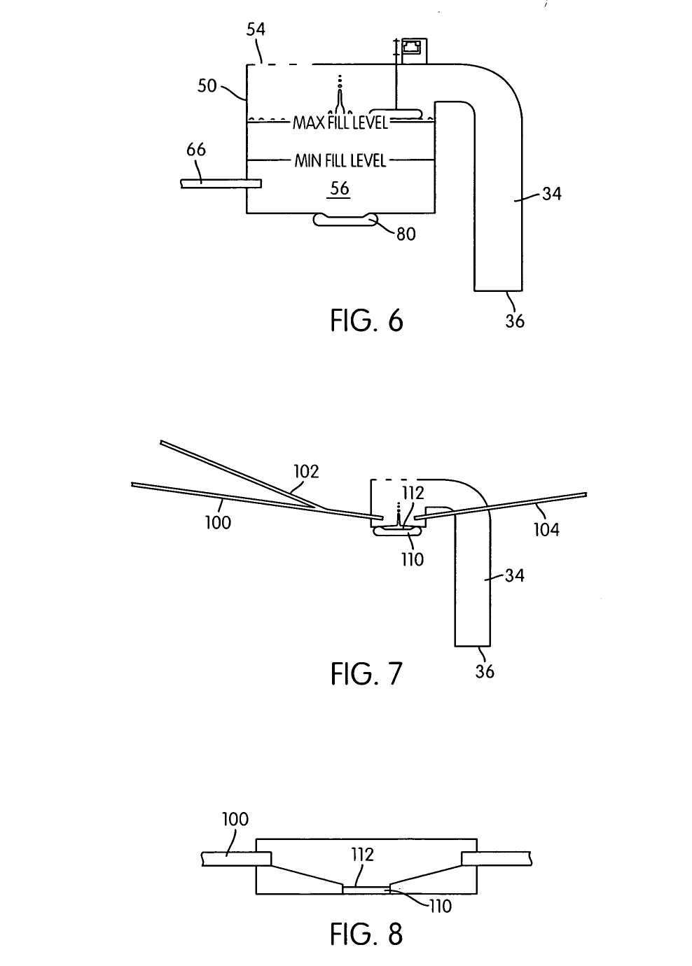

FIGS. 4 and 6 show the optional addition of a reservoir level sensor 90. As an example, this may be a float switch 92. The float switch has a buoyant float member 94 that floats in the reservoir 50 and is mounted to a rod 96. The upper end of the rod 96 is connected to a sensor 98. The sensor may be any suitable sensor, such as one using one or more magnetic switches or reed switches. The float 94 will rise and fall as the level of the liquid 56 in the reservoir 50 rises and falls. The sensor 98 is used to monitor the level of the liquid in the reservoir 50 by monitoring the height of the rod 96, which is attached to the float 94. The sensor 98 is also used to control the pump 60, and may be either electrically coupled directly to the pump 60, or to the controller 70. Either way, when the sensor 98 detects that the float 94, and hence the liquid level in the reservoir, is above a predetermined minimum fill level, the pump 60 will remain inactivated, as there is no need to pump additional solution/mixture into the reservoir 50. If the pump 60 is running and feeding liquid to the reservoir 50, the sensor 98 can be used to cease operation of the pump 60 upon the float 94, and hence the liquid level in the reservoir 50, reaching the maximum fill level. Likewise, if the float 94, and hence the liquid level in the reservoir 50, falls below the minimum fill level, the sensor 98 can detect this and be used to start operation of the pump 60 so that additional solution/mixture 56 is fed into the reservoir.

With the use of this sensor system, it can be ensured that the liquid level is within the proper range for enabling the fog generator 80 to operate and generate fog F. The range can depend on factors such as the type of fog generator 80 used, the frequency at which it is driven, etc.

The controller 70 manages the functions of the various parts. Preferably, the controller 70 includes a processor and/or dedicated circuitry for this purpose. The controller 70 controls the delivery of electrical power to the fog generator 80, the pump 60, and the motor of the fan 46. The controller 70 preferably connects to and receives power from a power source, such as a standard AC outlet. When the trap is not in use, no power is delivered to any of the components by the controller 70. When the trap is started by a user, the controller 70 can begin delivering power to the fan 46. Preferably, it also detects the state of the float switch sensor 98 to determine whether the liquid in the reservoir 50 is below the minimum fill level. If it is above that level, then it would begin delivering power to operate the fog generator 80; and if it is not, it would first deliver power to operate the pump 60 to supply the solution/mixture 56 to the reservoir 50. Once a satisfactory amount of liquid is in the reservoir 50, then the fog generator 80 would be supplied with power.

This control scheme for the controller 70 may be varied, and the one described above is not intended to be limiting. The scheme may vary based on the specific types and numbers of components used. Likewise, no particular order of steps or acts is particularly necessary.

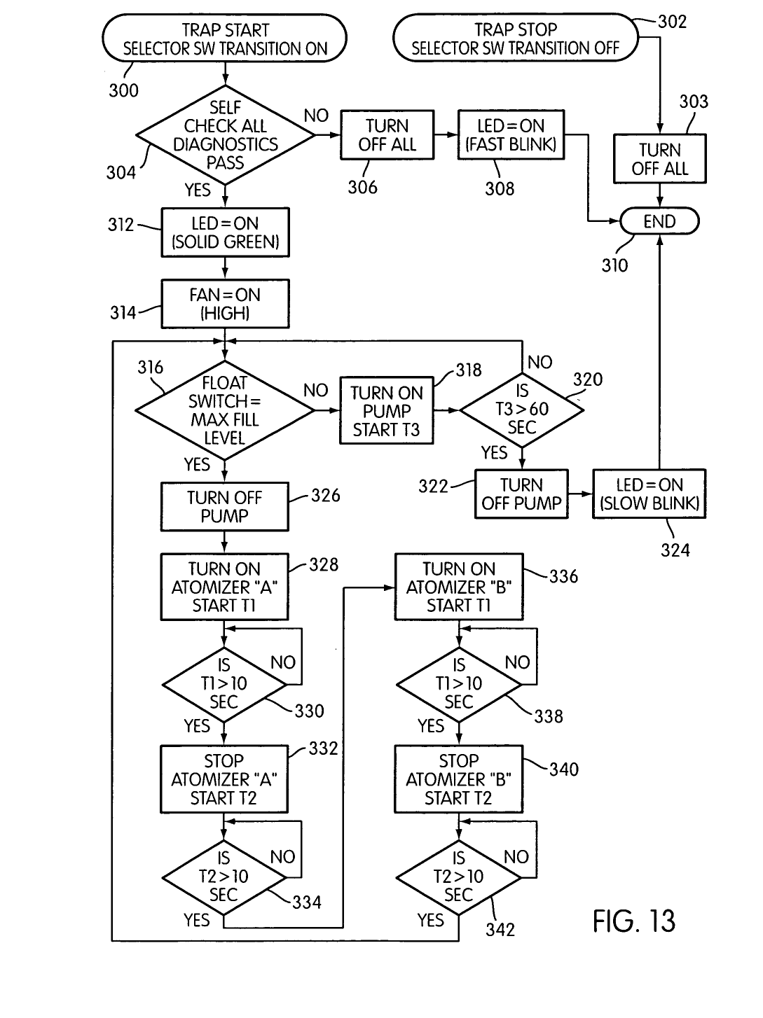

FIG. 13 illustrates an exemplary flowchart for controlling the operation of the apparatus 10. This logic may be hardwired into the circuitry of the controller 70, or provided in software format. This flowchart is exemplary only and is not intended to be limiting.

In block 300, the user has pushed or otherwise activated the START or ON switch of the apparatus 10. In block 302, the user has pushed the STOP or OFF switch of the apparatus. These switches could be provided by a single switch, such as of the toggle type, or by separate switches. Such a switch may of any construction, and would be provided on a user panel on the exterior of the apparatus.

Following from block 302, when the user has pushed or otherwise activated the STOP or OFF switch, in block 303 all functions of the apparatus 10 are terminated, and the logic ends at block 310.

Following from block 300, the next step is for the controller 70 to run a self diagnostic check per block 304. These checks are well known and are not described herein. If the check fails, the logic proceeds to block 306 where all functions of the apparatus 10 are terminated. Then, in block 308, an LED is activated to blink at a fast rate. This LED would preferably be located near the ON/OFF switch on the exterior of the apparatus 10, and would signal an error in the apparatus to the user.

If the check passes, then a green LED is activated in block 312. This LED would preferably be located near the ON/OFF switch on the exterior of the apparatus 10, and would signal to the user that the apparatus is beginning to function. Next, the fan 46 is activated in block 314. Then, in block 316, the controller 70 determines whether the level sensor 90 is at the maximum fill level.

If the level sensor is sensed as not being at the maximum fill level, then the pump is activated in block 318 and a timer T3 is started. In block 320, if the timer T3 has not reached 60 seconds, the logic loops back to block 316 to check whether the level sensor is sensed as being at the maximum fill level. If it is, then the logic proceeds on to block 326. If it is not, then the logic returns to block 320 through block 318 (the timer T3 is not restarted this time through). This loop will continue until either the level sensor 90 reaches the maximum fill level (thus proceeding the logic to block 326) or the timer T3 reaches 60 seconds.

If the timer has reached 60 seconds, this indicates that the supply has run out, and the logic moves to block 322 where the pump is turned off. Then the blinking LED mentioned above is activated to blink slowly, indicating to the user that the supply needs to be re-filled. The logic then proceeds to block 310 to end the process. Other indicators, such as a different LED or an audible noise, may be used.

In the situation where either the level sensor 92 is initially at the maximum fill level, or where it becomes so within 60 seconds as a result of the pump operating in block 318, the logic proceeds to block 326. In this block, the pump is turned off. Next, in block 328, the fog generator is activated and timer T1 is started. Block 330 determines when timer T1 reaches 10 seconds. Upon reaching 10 seconds, the generator is stopped in block 332 and timer T2 is started. Block 334 determines when timer T2 reaches 10 seconds. These operations are repeated in blocks 336, 338, 340, and 342. This results in the fog being generated in “bursts” or “pulses.” This is desirable for at least two reasons. First, it allows the fog to be released in incremental amounts, somewhat akin to mammalian exhalations, the typical prey of mosquitoes. Second, steady streaming of the fog may caused some of the droplets to “collide” as the fog is working its way out of the device, thus possibly forming larger droplets that become too large to be airborne. However, this pulsing action is merely preferred, and not necessary. Continuous fog generation may be used.

After block 342, the logic then returns to block 316, where the process continually repeats as described.

This exemplary flowchart is not limiting. Any of the variables may be changed, and any other suitable logic, steps, or sequences may be used.

In alternate embodiments, the attractant supply could comprise a liquid container containing the liquid and an attractant container containing the attractant separately from the liquid. This would be in lieu of keeping the liquid and the attractant together in the same container. There are various reasons for using separate containers, which may be dependent on the attractants used. For example, if a certain attractant could lose efficacy if exposed to water for a long period of time, it would be desirable to house and store that attractant in a separate container.

To manage delivery of the supply from different sources, the feeder may include a liquid feeder for feeding the liquid to the fog generator and an attractant feeder for feeding the attractant to the fog generator. FIGS. 7 and 8 show such an arrangement, where tube 100 is the liquid feeder and tube 102 is the attractant feeder. Another tube 104, which could be used in lieu of or in addition to tube 102, is also used as an attractant feeder. As can be seen from FIG. 7, attractant feeder tube 102 merges into liquid feeder tube 100 so that the liquid and attractant delivered by those tubes are mixed together just prior to delivery to the fog generator 80.

The use of separate attractant and liquid feeder could be implemented with the embodiment illustrated in FIGS. 1-6 if desired. However, as illustrated, these feeders 100, 102 and 104 (if used) deliver the liquid and attractant(s) directly to the surface of a non-submersible fog generator 110. The liquid and the attractant are fed to form a film on an operative surface 112 of the generator 110, which is the surface that faces upwardly. The generator 110 is preferably electromechanical, such as an ultrasonic device operable to vibrate at ultrasonic frequencies to generate the fog F from the film on the operative surface 112 of the ultrasonic device.

To maintain the film on the surface 112 of the fog generator 110, the feeder is operable to continually feed the liquid and the attractant to form the film on the operative surface 112 with a thickness that stays within a desired range. A preferred range for film thickness is 1 to 2 inches, but that range may vary based on certain factors. A range of 1-1.75 inches is preferred. These ranges may be used with any of the devices described above, or other devices. When used with devices in the ranges of 1.65 to 2.4 MHz, these film thicknesses generate droplets in desired ranges, which are discussed below.

To achieve this, any well known metering devices or pumps may be used. The specific type and construction of such devices would depend on the specific characteristics of the liquid or attractant being fed. Also, the metering could be achieved by gravity feed for either the liquid or the attractant if desired, which eliminates the need for a pump. For such an application, it would be desirable to use a valve for controlling flow. In general, any suitable construction or arrangement may be used.

In another embodiment, the attractant supply could comprise a container containing the liquid and the attractant mixed together, as shown in the embodiment of FIGS. 1-6, and the feeder feeds the liquid and the attractant mixed together into the reservoir such that the level of the mixed liquid and attractant in the reservoir is maintained to form the film on the operative surface of the ultrasonic device. This combines the formation of a film in the embodiment of FIGS. 7 and 8 with the single container of FIG. 1-6 for storing the liquid and attractant together.

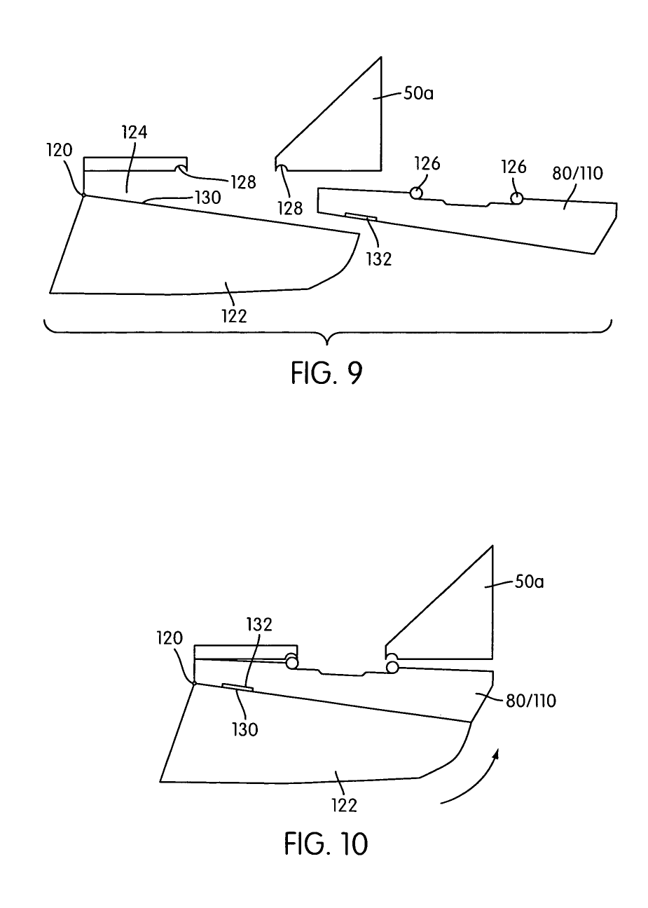

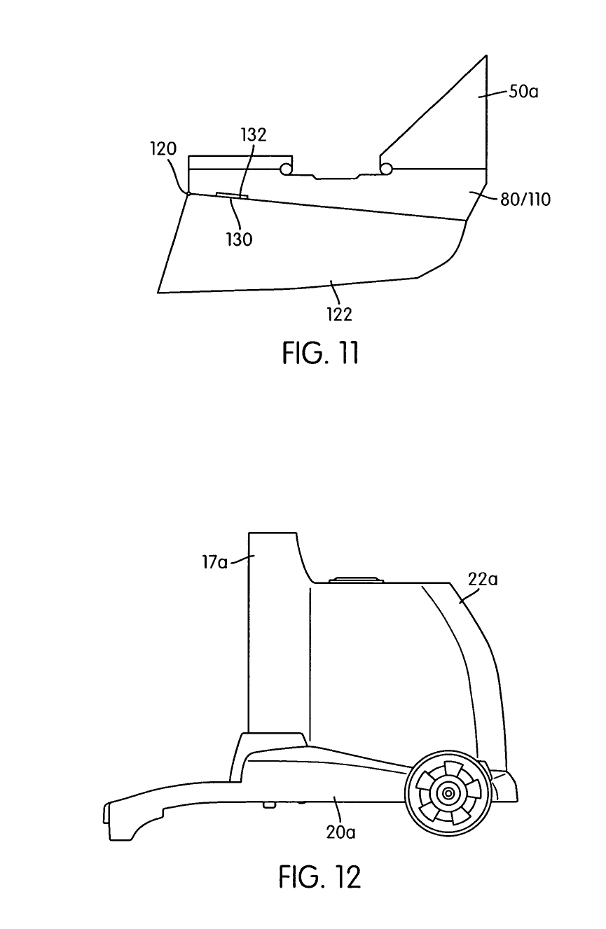

FIGS. 9-11 show an alternative embodiment especially designed for enabling easy removal and replacement of a fog generator 80/110. FIG. 9 is a schematic view of a mounting arrangement for removably mounting a fog generator in an open position with the fog generator 80/110 partially inserted. FIG. 10 shows the fog generator fully inserted into the mounting arrangement of FIG. 9. FIG. 11 shows the fog generator 80/110 fully inserted into the mounting arrangement of FIG. 9 in the closed position.

In these figures, the bottom wall 122 of the reservoir 50a is hingedly connected at pivot 120. This enables the wall 122 to be pivoted down to an open position, as shown in FIG. 9. In this condition, the fog generator 80/110 can be easily removed or replaced in the space shown at 124. In FIG. 10, the fog generator 80/110 is inserted into that space 124, and the bottom wall 122 is still pivoted to its open position. In FIG. 11, the wall 122 is pivoted up to place the fog generator 80/110 in its operative position. A suitable latch or lock (not shown) may be provided to secure the wall 122 in this closed position.

As can be seen from these figures, an annular seal or gasket 126 is mounted to the upper part of the fog generator 80/110, and a corresponding groove 128 is provided on the undersurface of the reservoir where the generator 80/110 will mount. The seal 126 is received in the groove 128 to create a seal that prevents liquid/attractant from leaking out the bottom of the reservoir 50a. Any other suitable sealing may be used and the illustrated construction is not intended to be limiting.

Optionally, a contact member 130 may be provided on wall 122 (or any other wall defining space 124), and a corresponding contact member 132 may be provided on the generator 80/110. Contact member 130 would be connected to the electrical power supply, typically through the controller 70. Contact member 132 would be connected to the active elements of the fog generator 80/110. When the contact members 130, 132 are engaged, power can be delivered through that connection. Likewise, when the contact members 130, 132 are disengaged, power delivery would be interrupted. The use of contact members 130, 132 positioned as shown avoids the need for establishing a separate connection, as the power connection is established simply by mounting the fog generator 80/110 in its operative position.

This variation for easier removal and replacement of the fog generator 80/110 is entirely optional.

FIG. 12 shows another alternate feature. In FIG. 12, the container 22a is formed as one integral piece with the supporting deck 20a. Also, the front wall of the container 22a is integrally formed with leg 17a. This is preferably accomplished by blow molding the parts from plastic, or using some other desirable technique.

When generating the fog F, it is desirable to control the size of the droplets for enhancing the ability to attract insects. As an example, it is desirable to generate the fog such that fog such that at least 50% or more of droplets in the fog are 3 microns or less in diameter. More preferably, 65% or more are 3 microns or less in diameter, and even more preferably 70% or more are 3 microns or less in diameter. Other suitable ranges may be used. For example, it is preferable to have 60% of the droplets be less than 5 microns in diameter, and more preferably to have 70% of the droplets be less than 5 microns in diameter. Likewise, it is desirable to generate the fog such that at least 40% of droplets in the fog are 1.5 microns or less in diameter, and more preferable to have at least 50% of the droplets 1.5 microns of less in diameter.

The preferred (but not necessary) temperature range for the fog exiting the device (i.e., as it exits the outlet opening) is within +/−15% of ambient temperature (i.e., the temperature of the air external to the device), and it is further preferred that the temper be within +/−10% of ambient temperature.

The droplet size ranges described are desirable because they behave much like the CO₂ plumes generated by the assignee's prior combustion-based devices, as described in the above-referenced patents and applications. That is, the fog plume will spread away from the device low to the ground, which is a desirable plume geometry for attracting insects.

Also, the droplet size ranges described are believed to be desirable because they may more easily permeate an insect's sencilla, thus better attracting the insect to follow the plume. It is believed that large droplets may not as easily permeate the sencilla. Of course, different insects exhibit different behaviors and sensing capabilities, and droplet size effect may vary among different insects (or different species of the same type of insect).

In an alternative embodiment, the fog generator may include two separate fog generators—one for the base liquid, and one for the attractant. Thus, the liquid and attractant would be fed separately to the two separate fog generators. Because two fog generators are used in this alternative embodiment, the structures described above in association with one fog generator may be duplicated for two (i.e., two pumps, two containers for the base liquid and the attractant, two reservoirs, etc.). Preferably, the output of each fog generator flows into separate conduits, and these conduits intersect at an angle (e.g., 45 degrees) to promote intermixing of the two output fogs for eventually flowing together out the apparatus outlet.

Preferably, but not necessarily, the fog generators each create small droplets on the order of 2-3 microns or less (and more preferably 2 microns or less). The droplets of each fog (i.e., the base liquid fog and the attractant fog) may collide and merge together to form mixed droplets having both attractant and the base liquid (typically water). The resulting “mixed” droplets would preferably be 5 microns or less in diameter. The intersection of the two conduits for the two fog outputs is preferably configured to encourage the collision of droplets from each fog to maximize the mixing as much as possible. Preferably, the relative surface tensions and miscibility of the base liquid and attractant are selected to facilitate merging of the drops.

It should be understood that the operating frequencies of the two fog generators could be different and tailored to the specific liquid being atomized. Likewise, the feed rates for delivery of the liquid and attractant could be different and tailored to the amount desired for atomization. Moreover, the number of separate fog generators need not be limited to two, and three or more could be used for higher numbers of liquids/attractants to be atomized.

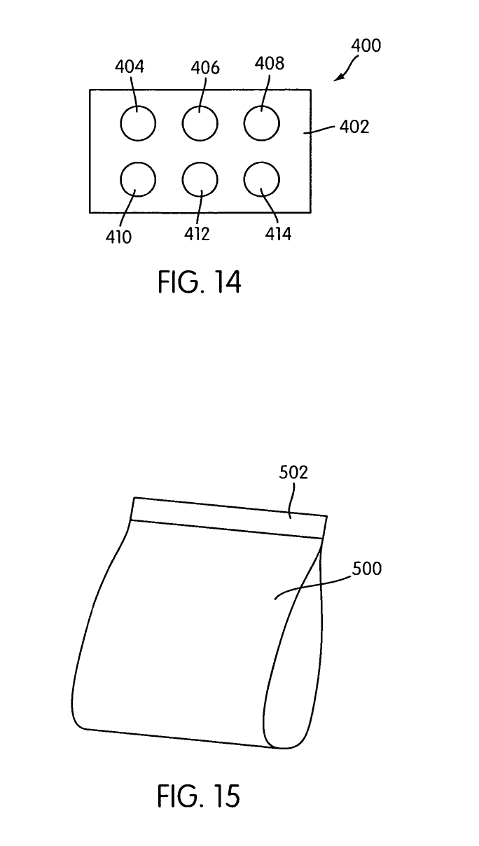

As an alternative embodiment for the ultrasonic devices described above, a multi-transducer type ultrasonic device could be used. FIG. 14 shows a top view of one example of such a device 400. The illustrated device 400 has a body 402 and six transducers, or active elements 404, 406, 408, 410, 412, 414, that each vibrate at ultrasonic frequencies as described above. The advantage of a multiple active element device 400 is that it will continue to function in the event one or more active elements (but less than all of them) ceases to operate.

An additional advantageous way of using the multiple active element device 400 is to use only a select number of the active elements, and keep the other ones inoperative. If one of the operating active elements malfunctions or ceases to operate, then one of the inoperative ones can be operated to take its place. For example, initially active elements 404, 408 and 412 may be operational, and active elements 406, 410, and 414 may be inoperative. A controller may monitor elements 404, 408 and 412 to determine if one ceases functioning or otherwise malfunctions (e.g., it vibrates at too high or too low of a frequency). If one of the elements 404, 408 and 412 is determined to have ceased operating or otherwise malfunctioned, then the controller can switch to one of the inoperative elements 406, 410 and 414 and start operating that one. For more even distribution of the active elements, the controller may switch to the inoperative active element closest to the one detected as having malfunctioned (e.g., malfunctioning element 404 would result in operating element 410, malfunctioning element 412 would result in activating element 406, and malfunctioning element 408 would result in operating element 414).

Although the active elements are illustrated as being in a 2×3 array, they may be arranged in any configuration. For example, a 3×3 array could be used, or they could be arranged in a triangular or generally circular configuration.

Thus, the operational scheme may be used to control operation of any number of active elements. Thus, in a broad generic sense, the controller will operate M of the active elements and leave N (the remainder) of the active elements inoperative, where M+N equals the plurality of active elements. In the illustrated embodiment, M equals 3 (active elements 404, 408 and 412), and N equals 3 (active elements 406, 410 and 414). When a controller detects that one of the M active elements has malfunctioned, it can operate one of the N active elements in lieu of the malfunctioned active element. This may continue during the life of the apparatus so long as one of the N active elements is still working properly.

In another alternative embodiment, the attractant S may be sold in liquid form in a sealed pouch 500, as illustrated in FIG. 15. The pouch 500 may have any construction, and the typical pouches used for children's juices (e.g., CAPRI-SUN) are one example of a suitable construction. The pouch 500 may be made of foil or plastic, or any other suitable fluid impervious material. The pouch 500 may be filled through an open end during manufacturing, and then sealed closed as shown at seal 502. The sealing may be by heat sealing, adhesive, or in any other manner.

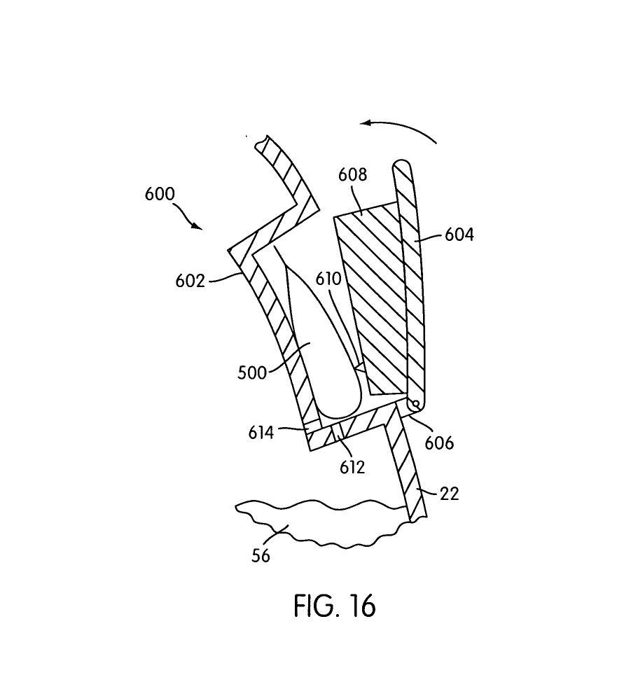

FIG. 16 shows an alternative embodiment, including an attractant release device 600 designed to easily pierce open the pouch 500. The structure illustrated in FIG. 16 is isolated from the remainder of the apparatus, but should be understood as being provided on an upper portion of the outer wall on container 22 at a position suitable for allowing liquid attractant to drain from pouch 500 down into the container for mixing with the base liquid.

The device 600 includes a receptacle 602 for receiving the pouch 500. The receptacle 602 is preferably configured with the same dimensions as the pouch 500. The receptacle 602 may be formed integrally with the wall of the container 22 as illustrated, or it may be a separate component attached to the container wall. Preferably, but not necessarily, the receptacle 602 extends into the interior of the container 22 as illustrated.

It should be understood that the attractant receptacle 602 may be configured for receiving other types of packages containing the liquid attractant, such as boxes, etc. Thus, the attractant release device 600 is not limited to releasing liquid from the illustrated pouch.

The receptacle 602 also has a movable structure in the form of a door 604 pivotally mounted to a pivotal connection at 606 for movement between an open position allowing placement of the pouch 500 in the receptacle 602, and a closed position closing the receptacle 602. The pivotal connection 606 may be a pair of ears that pivotally engage pins on opposing sides of the door 604. The door 604 preferably has an engaging portion 608 for pressing the pouch 500 against the receptacle wall to force out the liquid attractant. Engaging portion 608 may be integral with the door 604 or a separately formed component.

The engaging portion 608 preferably carries a cutter 610 for cutting or piercing the pouch 500. The cutter 610 may be provided by one or a series of pins, blades, serrated teeth, projection(s), etc. Any suitable structure for cutting or piercing the pouch wall may be used.

The receptacle 602 has one or more drain openings 612, 614 in its walls for allowing liquid attractant released from the pouch to flow out from the receptacle 602 and into the container 22.

In operation, the user will place the pouch 500 in the receptacle 602, and then close the door 604. Preferably, the door 604 has a releasable latch to keep it in the closed position. As the door 604 closes, the cutter 610 pierces or cuts the pouch 500, thus allowing liquid attractant to drain therefrom. Also, the engaging portion 608 engages and presses the pouch 500 and flattens the pouch 500 against the inner wall of the receptacle 602. This forcibly expels the liquid attractant from the pouch 500 and into the receptacle 602 so that it can drain into the container 22 by gravity for mixing with the base liquid 56. Preferably, the inner surface of engaging surface 608 will engage flush against the inner wall of receptacle 602 to fully compress the pouch 500 therebetween.

In one variation, the receptacle 602 or a wall thereof may be a cage or mesh structure, thus providing for easy drainage of the liquid attractant.

In another variation, the cutter 610 could be a lateral blade that fully serves the bottom part of the pouch 500 from the top part. Also, the cutter 610 could be movable and mounted on a spring so that, after piercing that pouch 500, it engages the inner wall of the receptacle 602 and is pushed inwardly into a bore against the spring bias. This would allow the engaging portion 604 to engage the receptacle wall in a flush manner. Alternatively, the receptacle wall may have an opening for allowing the cutter to pass through, thus avoiding any need for allowing it to retract into a bore.

The cutter 610 (or cutters) may also have grooves or reliefs on its surface for facilitating the flow of the liquid attractant out past the cutter(s) 610.

All the patents and applications mentioned herein are incorporated into the present application in their entirety.

The foregoing detailed description has been provided solely for purposes of illustrating the structural and functional principles of the present invention and is in no way intended to be limiting. To the contrary, the present invention is intended to encompass all variations, modifications, substitutions, alterations and equivalents within the spirit and scope of the appended claims.

What is claimed:

1. An insect trapping apparatus comprising:
a frame providing at least one outlet opening and at least one inlet opening, each of the outlet and inlet openings being communicated to a surrounding atmosphere;
an insect trap chamber communicated to the surrounding atmosphere through the at least one inlet opening;
at least one airflow generator operable to generate an inflow flowing inwardly from the surrounding atmosphere through the at least one inlet opening and then into the insect trap chamber, thereby enabling the inflow to draw insects attracted to the device into the insect trap chamber;
an attractant supply comprising an insect attractant and a liquid;
a feeder for feeding the attractant and the liquid;
a fog generator in communication with the feeder such that the feeder feeds the attractant supply to the fog generator,
the fog generator also being in communication with the at least one outlet opening and being operable to generate a fog comprising the liquid and the insect attractant for exiting through the at least one outlet opening for attracting insects to the device.

2. An insect trapping apparatus according to claim 1, wherein the fog generator is an ultrasonic device operable to vibrate at ultrasonic frequencies to generate the fog.

3. An insect trapping apparatus according to claim 2, wherein the liquid is water.

4. An insect trapping apparatus according to claim 2, wherein the insect attractant is a solid insect attractant in particulate form soluble or miscible in the liquid.

5. An insect trapping apparatus according to claim 2, wherein the insect attractant is a liquid insect attractant.

6. An insect trapping apparatus according to claim 1, wherein the attractant supply comprises a liquid container containing the liquid and an attractant container containing the attractant separately from the liquid.

7. An insect trapping apparatus according to claim 6, wherein the feeder includes a liquid feeder for feeding the liquid to the fog generator and an attractant feeder for feeding the attractant to the fog generator.

8. An insect trapping apparatus according to claim 6, wherein the attractant feeder and the liquid feeder feed the attractant and the liquid simultaneously to the fog generator.

9. An insect trapping apparatus according to claim 1, wherein the attractant supply comprises a container containing the liquid and the attractant together as a mixture or solution, and wherein the feeder feeds the mixture or solution to the fog generator.

10. An insect trapping apparatus according to claim 1, wherein the fog generator generates the fog such that at least 50% of droplets in the fog are 3 microns or less in diameter.

11. An insect trapping apparatus according to claim 10, wherein the fog generator generates the fog such that at least 65% of droplets in the fog are 3 microns or less in diameter.

12. An insect trapping apparatus according to claim 11, wherein the fog generator generates the fog such that at least 70% of droplets in the fog are 3 microns or less in diameter.

13. An insect trapping apparatus according to claim 1, wherein the fog generator generates the fog such that at least 60% of droplets in the fog are 5 microns or less in diameter.

14. An insect trapping apparatus according to claim 13, wherein the fog generator generates the fog such that at least 70% of droplets in the fog are 5 microns or less in diameter.

15. An insect trapping apparatus according to claim 1, wherein the fog generator generates the fog such that at least 40% of droplets in the fog are 1.5 microns or less in diameter.

16. An insect trapping apparatus according to claim 1, wherein the fog generator generates the fog such that at least 50% of droplets in the fog are 1.5 microns or less in diameter.

17. An insect trapping apparatus according to claim 2, wherein the feeder feeds the liquid and the attractant to form a film on an operative surface of the ultrasonic device, the ultrasonic device operable to vibrate at ultrasonic frequencies to generate the fog from the film on the operative surface of the ultrasonic device.

18. An insect trapping apparatus according to claim 2, wherein the feeder includes a reservoir and wherein the ultrasonic generator is a submersible ultrasonic generator received in the reservoir, the feeder being operable to feed the liquid and the attractant into the reservoir.

19. An insect trapping apparatus according to claim 18, further comprising a level sensor for sensing a level of the attractant supply in the reservoir.

20. An insect trapping apparatus according to claim 19, wherein feeder comprises one or more pumps for feeding the attractant supply to the reservoir.

21. An insect trapping apparatus according to claim 20, wherein the level sensor is communicated to the one or more pumps to enable (a) the one or more pumps to cease pumping the attractant supply upon the level sensor sensing that the attractant supply in the reservoir has reached a maximum fill level, and (b) the one or more pumps to start pumping the attractant supply into the reservoir upon the level senor sensing that the attractant supply in the reservoir has fallen to a minimum fill level.

22. An insect trapping apparatus according to claim 21, further comprising a controller.

23. An insect trapping apparatus according to claim 22, wherein the level sensor and the controller are each coupled to the controller, the controller receiving information from the level sensor to control the pump.

24. An insect trapping apparatus according to claim 1, further comprising a controller for controlling operation of the fog generator, wherein the controller controls the fog generator so as to generate the fog in intermittent pulses.

25. An insect trapping apparatus according to claim 2, wherein the ultrasonic device includes a plurality of active elements each operable to vibrate at ultrasonic frequencies.

26. An insect trapping apparatus according to claim 25, further comprising a controller for controlling the active elements,
wherein the controller is operable to operate M of the active elements, and leave N of the active elements inoperative, wherein M+N equals the plurality of active elements; and
wherein upon detecting that one of the M active elements has malfunctioned, operating one of the N active elements in lieu of the malfunctioned active element.

27. An insect trapping apparatus according to claim 9, further comprising an attractant release device provided on the container,
the attractant release device comprising a receptacle for receiving a package containing the attractant in liquid form, and a cutter for cutting or piercing the package, the attractant release device being communicated to an interior of the container and positioned to allow the liquid attractant to flow from the package into the container.

28. An insect trapping apparatus according to claim 27, wherein the attractant release device includes a movable structure configured to press the package against a wall of the receptacle for forcing the liquid attractant therefrom.

29. An insect trapping apparatus according to claim 28, wherein the cutter is provided on the movable structure.

30. An insect trapping apparatus according to claim 29, wherein the movable structure is a door configured to close the receptacle in a closed position, and movable to an open position for allowing placement of the package in the receptacle.

31. A method for attracting and capturing insects using an insect trapping apparatus comprising a frame providing at least one outlet opening and at least one inlet opening, each of the outlet and inlet openings being communicated to a surrounding atmosphere; an insect trap chamber communicated to the surrounding atmosphere through the at least one inlet opening; and at least one airflow generator operable to generate an inflow flowing inwardly from the surrounding atmosphere through the at least one inlet opening and then into the insect trap chamber, thereby enabling the inflow to draw insects attracted to the device into the insect trap chamber;
emitting a fog comprising a liquid and an insect attractant through the at least one outlet opening for attracting insects to the device; and
generating, with the at least one airflow generator, the inflow flowing inwardly from the surrounding atmosphere through the at least one inlet opening and then into the insect trap chamber, thereby enabling the inflow to draw insects attracted to the device by the fog into the insect trap chamber.

32. A method according to claim 31, wherein the fog generator is an ultrasonic device and wherein the method comprises vibrating the ultrasonic device at ultrasonic frequencies to generate the fog.

33. A method according to claim 32, wherein the liquid is water.

34. A method according to claim 31, wherein the insect attractant is a liquid insect attractant.

35. A method according to claim 31, wherein the attractant supply comprises a liquid container containing the liquid and an attractant container containing the attractant separately from the liquid.

36. A method according to claim 35, wherein the feeder includes a liquid feeder and an attractant feeder, said method comprising feeding the liquid to the fog generator with the liquid feeder and feeding the attractant to the fog generator with the attractant feeder.

37. A method according to claim 36, wherein the attractant feeder and the liquid feeder feed the attractant and the liquid simultaneously to the fog generator.

38. A method according to claim 31, wherein the attractant supply comprises a container containing the liquid and the attractant together as a mixture or solution, and wherein the feeder feeds the mixture or solution to the fog generator.

39. A method according to claim 31, wherein the fog generator generates the fog such that at least 50% of droplets in the fog are 3 microns or less in diameter.

40. A method according to claim 39, wherein the fog generator generates the fog such that at least 65% of droplets in the fog are 3 microns or less in diameter.

41. A method according to claim 40, wherein the fog generator generates the fog such that at least 70% of droplets in the fog are 3 microns or less in diameter.

42. A method according to claim 31, wherein the fog generator generates the fog such that at least 60% of droplets in the fog are 5 microns or less in diameter.

43. A method according to claim 42, wherein the fog generator generates the fog such that at least 70% of droplets in the fog are 5 microns or less in diameter.

44. A method according to claim 41, wherein the fog generator generates the fog such that at least 40% of droplets in the fog are 1.5 microns or less in diameter.

45. A method according to claim 44, wherein the fog generator generates the fog such that at least 50% of droplets in the fog are 1.5 microns or less in diameter.

46. A method according to claim 41, wherein the feeder feeds the liquid and the attractant to form a film on an operative surface of the ultrasonic device, the ultrasonic device being operated to vibrate at ultrasonic frequencies to generate the fog from the film on the operative surface of the ultrasonic device.

47. A method according to claim 42, wherein the feeder includes a reservoir and wherein the ultrasonic generator is a submersible ultrasonic generator received in the reservoir, wherein the feeder feeds the liquid and the attractant into the reservoir.

48. A method according to claim 47, wherein the insect trapping apparatus further comprises a level sensor that senses a level of the attractant supply in the reservoir.

49. A method according to claim 48, wherein the apparatus comprises one or more pumps that feed the attractant supply to the reservoir.

50. A method according to claim 49, wherein the level sensor is communicated to the one or more pumps, wherein the method further comprises: (a) ceasing pumping of the one or more pumps to cease pumping the attractant supply upon the level sensor sensing that the attractant supply in the reservoir has reached a maximum fill level, and (b) operating the one or more pumps to start pumping the attractant supply into the reservoir upon the level sensor sensing that the attractant supply in the reservoir has fallen to a minimum fill level.

51. A method according to claim 50, further comprising a controller, the controller controlling the operation of the one or more pumps based on the level sensor.

52. A method according to claim 51, wherein the fog is emitted in intermittent pulses.

53. A method according to claim 32, wherein the ultrasonic device includes a plurality of active elements each being vibrated at ultrasonic frequencies to generate the fog.

54. A method according to claim 53, wherein a controller operates M of the active elements, and leaves N of the active elements inoperative, wherein M+N equals the plurality of active elements; and
upon detecting that one of the M active elements has malfunctioned, operating one of the N active elements in lieu of the malfunctioned active element.

55. A method according to claim 38, wherein the insect trapping apparatus further comprises an attractant release device provided on the container, the method further comprising:
disposing a package containing the attractant in liquid form in an attractant receptacle of the attractant release device; and
using a cutter to pierce or cut the package to allow the liquid attractant to flow from the package into the container.

56. A method according to claim 55, wherein the method further comprises moving a movable structure of the attractant release device to press the package against a wall of the receptacle for forcing the liquid attractant therefrom.

57. A method according to claim 56, wherein the cutter is provided on the movable structure and moving the movable structure as aforesaid also causes the cutter to cut or pierce the package.

58. A method according to claim 57, wherein the movable structure is a door and moving the movable structure as aforesaid comprises moving the door from (a) an open position for allowing the package to be disposed in the attractant receptacle, and (b) a closed position closing the receptacle.
